(19) United States
(12) Patent Application Publication
(10) Pub. No.: US 2017/0241398 A1
(43) Pub. Date: Aug. 24, 2017

(54) Torque Control

(71) Applicant: David Shield, Derby (GB)

(72) Inventor: David Shield, Derby (GB)

(21) Appl. No.: 15/436,913

(22) Filed: Feb. 20, 2017

(30) Foreign Application Priority Data
Feb. 18, 2016 (GB) 1602827.6

(51) Int. Cl. F03B 13/20; F16H 19/08

(52) U.S. Cl. CPC F03B 13/20; F16H 19/08; F05B 2260/40311; F16H 48/08

(57) ABSTRACT

A power take-off arrangement for a wave energy converter is described. The arrangement has a gearbox having a first shaft (20) connected to the wave energy converter (1) which is adapted to receive, in use, rotational motion from the wave energy converter. The gearbox has a second shaft connecting the annulus gear (31) to the generator shaft (36). A third shaft (38) is connected to one or more means (39) of applying torque to it. Torque applied by the one or more means (39) may be varied in operation so as to alter the relative rotational velocities and accelerations of the second and third shafts in response to any given rotational velocity or acceleration of the first shaft.

### BACKGROUND OF THE INVENTION

The present invention relates to power transmission systems for wave energy converters. More particularly, the present invention relates to a means of connecting the prime mover of such an energy converter to the means for converting motion to another form of energy (such as an electrical generator) which is able to control and limit the loads and speeds experienced by the power transmission system.

Wave energy—the capture and conversion of energy from wind-generated ocean surface waves—has the potential to be a significant source of renewable electricity generation. It is characterised by high energy density, and a slower variation in the amount of energy available over time compared to other renewable sources such as wind energy.

A number of Wave Energy Converter (WEC) device types have been proposed to capture this energy. In one such type (commonly referred to as a point absorber), a buoyant body is connected to the sea bed by a mooring cable. As the water surface rises and falls with passing waves, the buoyant body follows this vertical motion, necessitating a change of length of the mooring cable. Energy is extracted by providing a resistance to this change of length.

Another type of device, commonly referred to as an attenuator, comprises two or more floating bodies coupled together. The couplings between the bodies are arranged so as to permit relative motion between the bodies as the waves, typically around one or more axes of rotation. Energy is extracted by providing a resistance to this relative motion.

Another type of device, commonly referred to as an oscillating wave surge converter (OWSC) is typically positioned closer to shore, where the particle motion of the waves has a greater horizontal (surge) component. The horizontal motion causes a paddle to rotate backwards and forwards about a pivot point relative to a fixed base. Energy is extracted by providing a resistance to this relative motion.

Various other WEC device types have been proposed, which will not be described here. As with the types described above, many of these arrangements result in a rotational motion about an axis, hinge, or pivot, or in a translational motion which might readily be converted to rotational motion by means such as a cable wound around a drum.

One of the challenges facing wave energy generation is to effectively convert the relative rotary motion between parts of the WEC (the prime mover) into electricity which can be supplied to the distribution grid. The sub-system of the WEC which performs this function is referred to as the power take-off (PTO).

The motion of the prime mover is characterised by:
low rotation speeds when compared with other power generation equipment such as wind turbines,
high torque, and in particular a high ratio between ‘normal’ and ‘extreme’ loading, intermittent loading,
continual variation of torque and speed,
periodic reversal of rotation direction.

For a given power output, an electrical generator which is designed to operate at a low speed and high torque will necessarily be much larger than one which is designed to operate at high speed and low torque. In the wind energy industry, extremely low speed generators have been proposed which are able to operate at the wind turbine rotor speed, removing the requirement for a gearbox or other speed-increasing transmission system to be interposed between rotor and generator. However it has been seen that the increased cost associated with such a generator tends to outweigh the savings from simplifying the transmission system, and thus the majority of wind turbines still incorporate some form of speed-increasing transmission system. Since the speeds associated with wave energy are even lower, it appears even more likely that the most cost-effective solution will similarly incorporate a speed-increasing transmission between the prime mover and the generator.

The high ratio between normal and extreme loading requires either: that the PTO system is designed to withstand the highest possible loads, adding cost and weight to the system; or that loads are controlled in high wave conditions by reducing the resistance of the PTO to relative motion of the WEC bodies below the theoretical optimum level, at the cost of reduced energy capture. In extreme conditions, the WEC might be placed in a survival mode whereby energy capture is shut off entirely, reducing the resistance to near-zero and permitting the WEC to freely follow the surface of the water.

As the rotational speed of the generator varies, so will the frequency of the electrical output. Power converters are typically fitted between the generator and the electrical distribution grid in order to accommodate this variation and deliver a constant frequency output to the grid. The range of input frequencies which can be handled by power converters is wide, but finite. The typical range of speeds associated with a WEC device is wider than the capacity of typical, commercially available power converters. A certain amount of energy production may therefore be lost at the high- and low-speed extremes of WEC motion because it cannot be delivered to the grid.

Many of the WEC devices currently proposed incorporate hydraulic fluid transmission systems. The motion of the prime mover is used to create a flow of pressurised hydraulic fluid—either through a rotary pump or pumps; or through a linear piston or pistons offset from the rotation axis. The working fluid may be oil or water based. The flow of fluid is then passed through a turbine arrangement, either mounted within the WEC itself, or located remotely (even onshore) and connected by pipes. The turbine is connected to a generator which produces electricity.

Such a fluid transmission system is readily and economically implemented. However it suffers from considerable transmission losses—typically less than 80% of the power introduced into the system by the prime mover will reach the generator, even under optimum conditions. When operating at part load (as is inevitable given the variability of the wave input) the efficiency is typically even lower. Since the overall conversion efficiency of the device is one of the most significant factors in determining the overall Cost of Energy (more so than the capital cost of the device itself), this represents a significant disadvantage to the use of such fluid transmission systems.

Geared transmissions are widely used across a wide range of industries and applications, and are capable of achieving very high transmission efficiencies. In applications such as wind energy, the mechanical conversion efficiency from prime mover to generator is typically greater than 97%, considerably greater than that achievable by a fluid power system. Furthermore, the efficiency is not significantly different when operating at part load.

A significant challenge facing the implementation of a geared transmission in a WEC is the referred rotational inertia which the PTO presents to the WEC device. Any acceleration of the WEC will result in an associated inertial torque to accelerate the PTO. During normal operation at moderate accelerations, this effect may not be significant relative to the torque reaction being applied by the generator. However in extreme conditions, when accelerations of the WEC will be many times higher, the inertial torque will be correspondingly greater, and unlike the generator torque reaction, cannot simply be turned off to ride out such conditions.

A major contributor to the referred inertia is the generator itself, since it is both relatively large and rotating at a higher speed than the input. Referred inertia increases with the square of the transmission ratio, so although operating the generator at a higher speed is beneficial in terms of cost and packaging, it has an impact on the dynamic behaviour of the system and the loads experienced in extreme conditions.

Patent EP2425123 discloses a water powered electrical generator in which the prime mover is connected to the generator by a geared transmission. In one of the disclosed embodiments of this invention, the geared transmission is configured to drive the generator in a single rotational direction in response to an oscillating input. This is achieved by providing two separate transmission paths, each of which incorporates an element which is only able to transmit torque in one of two rotation directions. The potential advantage of such an arrangement is to reduce the variability of generator speed, thus maximising the conversion efficiency and the time that it is able to be connected to the electricity grid. However it is likely that such a system would experience high dynamic loading of the transmission at the instant each one-way transmission element was engaged. A practical implementation of this system would probably therefore require some way of mitigating these dynamic loads.

Patent application WO 2011/126451 discloses a gearbox arrangement, particularly a planetary gear arrangement, which permits a portion of the input power to be extracted by an electrical generator, while another portion is transmitted into an energy accumulation device. This device is intended for installation in an attenuator buoy configured for single-acting operation—where energy is only extracted from the prime mover for motion in one direction. The energy accumulation device is configured to store a portion of the energy extracted during motion in this first direction, and return it to the generator during motion in the return direction, in order to achieve more uniform generator speed through the full cycle of motion.

The arrangement of WO 2011/126451 provides a way of mitigating some of the limitations of a single-acting WEC device. However it is primarily a way of controlling speed variations, and its capability to control extreme load variations is limited. The resistance of the energy accumulator system is fixed, and the division of energy between the generator and accumulator is controlled only by varying the torque reaction of the generator—in other words by varying the amount of energy which is being supplied to the grid. The accumulator can only be charged by movement of the WEC in the driving direction, and can only return energy to the generator during movement in the return direction. Additionally, it does not appear possible to incorporate this device into a double-acting WEC such as an attenuator.

In the arrangements described in WO 2011/126451, the gearbox is protected from overload by a sliding clutch in the main torque path, controlled either actively or passively to slip above a certain torque threshold. This sliding clutch is positioned at a relatively high-torque part of the system, on the input side of the gearbox, which may limit the potential for this system to be implemented in a larger utility-scale device. Furthermore, a sliding clutch, particularly a passive device, will experience wear as a result of its operation, with every high-torque event using a proportion of the clutch life and necessitating periodic maintenance.

It will be seen therefore that a geared transmission system which achieved very high transmission efficiency relative to fluid transmission systems, but which also incorporated a torque control system permitting the resistance (and in particular the inertial resistance) of the PTO system to be reduced rapidly in the event of high input loads or motions—either for a short time to deal with individual load events, or to enable the machine to be placed in a ‘survival’ mode over longer periods; which was applicable to single and double-acting WEC devices; and enabled a controlled return from this reduced resistance state to the normal operating condition; would be advantageous in maximising the survivability and energy output of such a WEC device. Ideally the transmission arrangement would minimise the required torque capacity, and thus cost, of the torque control system, and enable component wear (and thus maintenance requirements) to be minimised.

Further advantage might be gained if the torque control system is able to convert some or all of the energy extracted from the system by its operation to electrical energy, either to increase the energy output of the WEC, or to provide auxiliary power to the WEC in the event that the grid connection is lost.

### BRIEF SUMMARY OF THE INVENTION

According to a first aspect, the invention provides a power take-off arrangement for a wave energy converter which includes a gearbox. The gearbox comprises a first shaft connected to the wave energy converter and adapted to receive, in use, rotational motion from the wave energy converter. The gearbox also comprises a second shaft connected to a generator, and a third shaft connected to one or more means of applying torque to it. The torque applied by the one or more means may be varied in operation so as to alter the relative rotational velocities and accelerations of the second and third shafts in response to any given rotational velocity or acceleration of the first shaft.

Preferably, the gear box is a three-way planetary gear arrangement.

Preferably, the third shaft of the gearbox is connected to a central sun gear of the planetary gear arrangement.

Preferably, the three-way gearing arrangement includes bevel gearing.

Preferably, the first shaft is connected to the wave energy converter by direct connection or via another portion of the power take-off arrangement. Preferably, the first shaft is adapted to receive, in use, unidirectional rotational motion.

Preferably, the means of applying torque to the third shaft comprises a disc brake. Preferably, the means of applying torque to the third shaft comprises a hydraulic pump. Preferably, the means of applying torque to third shaft comprises an electrical generator. Preferably, the means of applying torque to third shaft comprises a motor generator.

According to a further aspect, the invention provides a wave energy converter comprising a power take-off arrangement as described in any of the preceding claims.

According to a further aspect, the invention provides a method of operating a power take-off arrangement as described above comprising reducing torque applied to the third shaft when the instantaneous loading on the transmission system exceeds a load limit for the wave energy converter.

Preferably, reducing torque applied to said the shaft achieves a survival state

Preferably, modulating the torque maintains a constant rotation speed at a main generator.

Preferably, applying torque to the third shaft and the electrical generator or motor generator generates electricity which may be exported to the grid or used to power on-board systems.

### BRIEF DESCRIPTION OF THE SEVERAL VIEWS OF THE DRAWINGS

FIG. 1 shows an example of an attenuator-type wave energy converter of the prior art;

FIG. 2 shows one embodiment of a power take-off of the present invention suitable for mounting in the hinge of the wave energy converter of FIG. 1;

FIG. 3 shows an embodiment of the invention in which the means of applying torque to the third shaft comprises a disc brake mounted on the shaft and a number of brake calipers mounted to the housing;

FIG. 4 shows an embodiment of the invention in which the means of applying torque to the third shaft comprises both a disc brake and a hydraulic pump;

FIG. 5 shows a schematic view of a system by which the flow of hydraulic fluid produced by the hydraulic pump of FIG. 4 may be used to generate electrical power; and

FIG. 6 shows an embodiment of the invention in which the means of applying torque to shaft comprises both a disc brake and an electrical generator or optionally motor/generator.

### DETAILED DESCRIPTION OF THE INVENTION

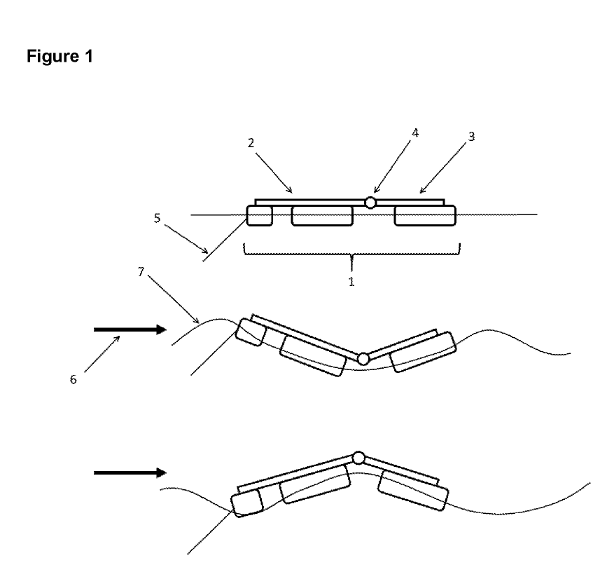

Referring now to FIG. 1, which shows an example of an attenuator-type wave energy converter (1) of the prior art comprising a first buoyant pontoon assembly (2) and a second buoyant pontoon assembly (3), connected by a hinge (4) which permits relative rotation of the pontoon assemblies around the hinge axis. The first pontoon assembly is restrained by a mooring (5) to the sea bed. In response to an incoming wave stream in direction (6) the pontoon assemblies (2, 3) will tend to follow the water surface (7), causing a reciprocating rotational motion at the hinge (4). This is an example of the type of device to which the present invention may be fitted.

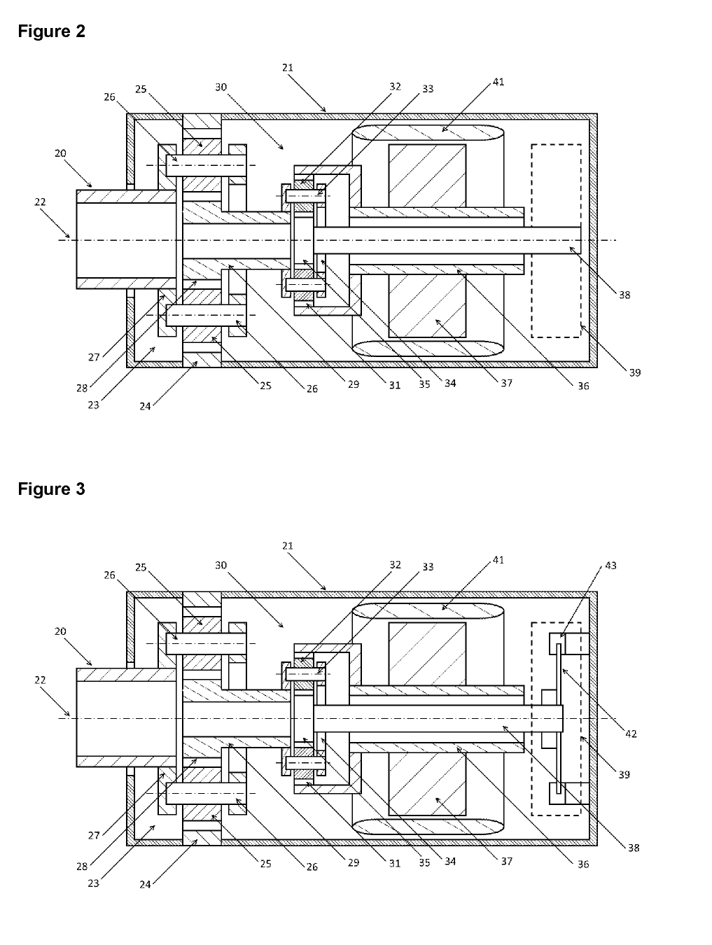

Thus, FIG. 2 shows one embodiment of a power take-off of the present invention suitable for mounting in the hinge (4) of the wave energy converter (1) of FIG. 1. The mounting arrangement is such that the motion of the wave energy converter produces a relative rotation between the input shaft (20) and the housing (21) about the axis (22).

In this arrangement, there is a primary planetary gearing stage (23), comprising an annulus gear (24) which is rigidly mounted in the housing (21). A number of planet gears (25) are rotatably mounted on planet pins (26), the pins in turn being supported by a planet carrier (27). The planet gears (25) are arranged in mesh with the annulus gear (24). A central sun gear (28) is mounted on a sun shaft (29) and arranged in mesh with the planet gears (25).

There is also a second planetary gearing stage (30), again comprising an annulus gear (31), planet gears (32), planet pins (33), a planet carrier (34) and a sun gear (35). The planet carrier (34) is torsionally connected to the sun shaft (29) of the first planetary gearing stage (23). The annulus gear (31) is torsionally connected to the rotor shaft (36) of a generator. The sun gear (35) is mounted on a sun shaft (38) which extends axially through the bore of the generator rotor shaft (36) and is torsionally connected to a means (39) of controlling the torque applied to the shaft (40). The generator additionally comprises stator windings (41) mounted in the housing (21) such that rotation of the generator rotor (37) produces a current in the windings (41).

In operation, it will be apparent that if the shaft (38) is constrained such that it cannot rotate with respect to the housing (21), rotational of the input shaft (20) will cause rotation of the generator rotor shaft (36) with a fixed speed ratio determined only by the numbers of teeth in the planetary gear arrangements (23) and (30). If, however, the sun shaft (38) is permitted to rotate, the second planetary gearing arrangement (30) acts as a differential or three-way gearing arrangement in which the ratio of speeds between any two of the input shaft (20), generator rotor shaft (36) and sun shaft (38) is dependent on the speed of the third. Thus by controlling the magnitude and direction of torque applied to the shaft (38), the acceleration of the generator rotor shaft (36) in response to a given acceleration of the input shaft (20) may be varied across a wide range.

Thus the gearbox has a first shaft (20) connected to the wave energy converter (1) which is adapted to receive, in use, rotational motion from the wave energy converter. The gearbox has a second shaft connecting the annulus gear (31) to the generator shaft (36). A third shaft (38) is connected to one or more means (39) of applying torque to it. Torque applied by the one or more means (39) may be varied in operation so as to alter the relative rotational velocities and accelerations of the second and third shafts in response to any given rotational velocity or acceleration of the first shaft.

FIG. 3 shows an embodiment of the invention in which the means (39) of applying torque to shaft (38) comprises a disc brake (42), mounted on the shaft (38), and a number of brake calipers (43) mounted to the housing (21).

In a first mode of operation, the brake calipers are used to prevent the disc (42), shaft (38), and sun gear (35) from rotating relative to the housing (21). Since the sun shaft (38) is the lowest torque part of the geared system, the torque capacity of the brake disc (42) and calipers (43) is minimised by this layout. In this mode, all power entering the transmission from the input shaft (20) is extracted from the generator (37, 41).

In a second mode of operation, the brake calipers are released, allowing rotation of disc (42), shaft (38) and sun gear (35) relative to the housing (21). In response to a given acceleration of the input shaft, both the generator rotor shaft (36) and the sun shaft (38) will accelerate, the relative accelerations being determined by the relative inertias of these two shafts and the components mounted to them, and the torque acting on the generator. Since the inertia of the sun shaft (38) and associated components will be considerably lower than that of the generator rotor shaft (36) and associated components, the acceleration of the sun shaft (38) will be higher.

The system may transition from the second mode of operation to the first mode of operation by reapplying pressure to the brake calipers (43). This may be done while the shaft (38) is moving, in which case power will be dissipated as heat until the speed of the shaft (38) relative to the housing (21) is reduced to zero. Alternatively, the application of the brakes may be timed to coincide with the speed reducing to zero as the WEC reverses direction. By applying the brakes at this point the wear on the brake pads is effectively zero. This is accomplished by means of a controller and means for sensing rotational velocities and torques (not shown).

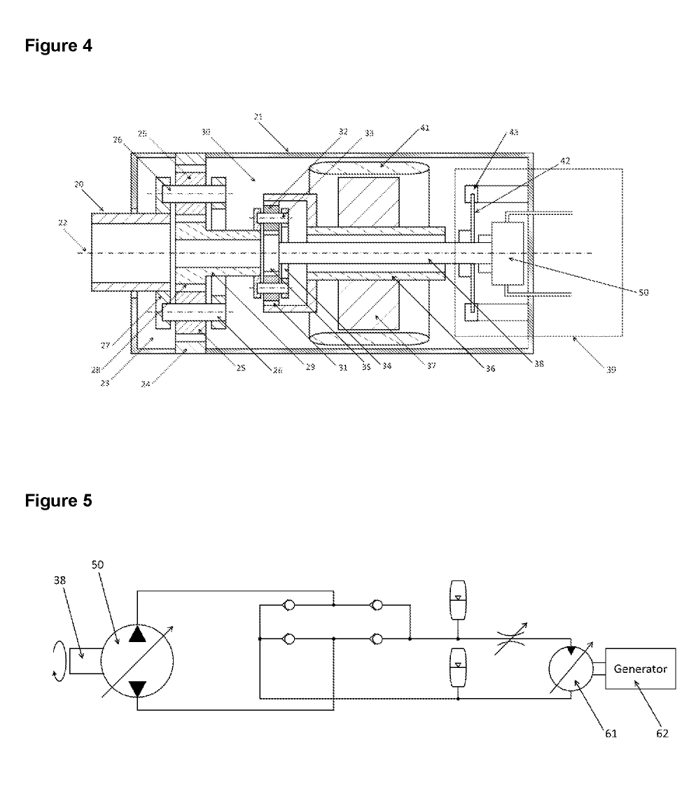

FIG. 4 shows an embodiment of the invention in which the means (39) of applying torque to shaft (38) comprises both a disc brake (42) and a hydraulic pump (50).

FIG. 5 shows a schematic view of a system by which the flow of hydraulic fluid produced by the hydraulic pump (50) of FIG. 4 may be used to generate electrical power.

In a first mode of operation of such a combined system, as shown in FIG. 3, the brake calipers (43) are used to prevent the disc (42), shaft (38) and sun gear (35) from rotating. All power entering the transmission from the input shaft (20) is extracted from the generator (37, 41).

In a second mode of operation, the brake calipers (43) release the disc (42), permitting rotation of the shaft (38) and attached hydraulic pump (50). Rotation of the hydraulic pump (50) causes a movement of hydraulic fluid. A connected hydraulic system such as that shown in FIG. 5 may be controlled by a supervisory system to vary the resistance to this fluid flow. The resistance is created by extracting energy through the hydraulic motor (61) and attached electrical generator (62). At low resistance, the behaviour of the system will be similar to the second mode of operation of the system of FIG. 3. Increasing the resistance of the hydraulic system will increase the proportion of any given acceleration of the input shaft (20) which is transferred to the generator rotor shaft (36), and reduce the proportion which is transferred to the sun shaft (38). By further increase in resistance, the majority of the braking energy dissipation required to transition from the second mode of operation to the first mode of operation may be achieved by the hydraulic system (and thus converted to useful electrical energy) with only a smaller, final portion achieved by the disc brake (42) to bring the speed of the sun shaft relative to the housing to zero and hold it there.

In a third mode of operation, the brake is released whenever the main generator rotor (37) approaches the maximum rotational speed and electrical output frequency which can be accommodated by the power converters. Further acceleration of the prime mover will largely result in acceleration of the shaft (38) and hydraulic pump (50). The main generator (37, 41) is able to remain connected to the grid while the additional power is extracted by the hydraulic system and secondary generator (62).

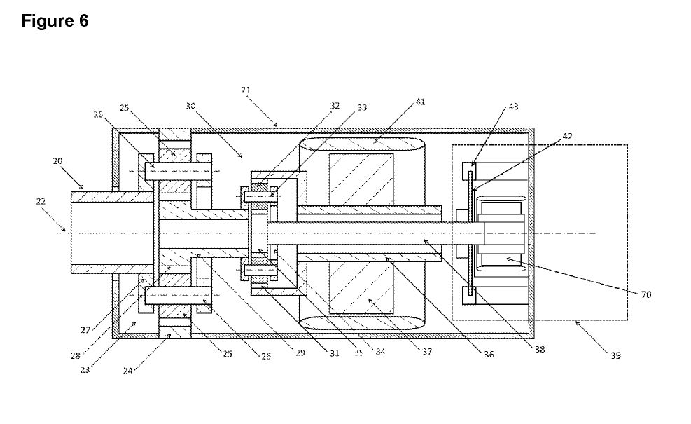

FIG. 6 shows an embodiment of the invention in which the means (39) of applying torque to shaft (38) comprises both a disc brake (42, 43) and an electrical generator or optionally motor/generator (70). This system is able to operate in the same modes of operation as the system of FIG. 4, but additionally is able to feed energy back into the system—the energy being drawn either from storage capacity on board the WEC or from the electricity grid. This capability may provide additional flexibility in ensuring the rotation speed of the main generator (37, 41) spends the maximum amount of time operating within the frequency envelope of the power converters.

It will be apparent that other embodiments of the present invention are possible which are not described here. For example, the three-way gearing arrangement described may be achieved by other arrangements of planetary gearing, or by arrangements of bevel gearing, as is common in automotive differentials. The primary gearing stage (23) may be replaced by an alternative gearing arrangement, by multiple gearing stages, or omitted entirely such that the input shaft (20) was directly connected to the planet carrier (34), depending on the desired range of overall transmission ratios to be achieved by the system.

The present invention could be arranged to form part of a power take-off system also comprising the transmission system described in Patent EP2425123. In operation, the torque control capabilities of the present invention could be used to mitigate the dynamic shock-loading associated with the engagement of the one-way transmission elements, thus allowing the advantages of uni-directional generator rotation described in Patent EP2425123 to be realised.

1. A power take-off arrangement for a wave energy converter, the power take-off arrangement including:
a gearbox comprising:
a first shaft connected to the wave energy converter and adapted to receive, in use, rotational motion from the wave energy converter;
a second shaft connected to a generator; and
a third shaft connected to one or more means of applying torque thereto;
characterised in that the torque applied by the one or more means may be varied in operation so as to alter the relative rotational velocities and accelerations of the second and third shafts in response to any given rotational velocity or acceleration of the first shaft.

2. The power take-off arrangement according to claim 1, wherein the gear box is a three-way planetary gear arrangement.

3. The power take-off arrangement according to claim 2, wherein said third shaft of the gearbox is connected to a central sun gear of the planetary gear arrangement.

4. The power take-off arrangement according to claim 2, wherein the three-way gearing arrangement includes bevel gearing.

5. The power take-off arrangement according to claim 1, wherein the first shaft is connected to the wave energy converter by direct connection or via another portion of the power take-off arrangement.

6. The power take-off arrangement according to claim 1, wherein the first shaft is adapted to receive, in use, unidirectional rotational motion.

7. The power take-off arrangement according to claim 1, wherein the means of applying torque to the third shaft comprises a disc brake.

8. The power take-off arrangement according to claim 6, wherein the means of applying torque to the third shaft comprises a hydraulic pump.

9. The power take-off arrangement according to claim 6, wherein the means of applying torque to third shaft comprises an electrical generator.

10. The power take-off arrangement according to claim 6, wherein the means of applying torque to third shaft comprises a motor generator.

11. A wave energy converter comprising a power take-off arrangement as described in claim 1.

12. A method of operating a power take-off arrangement according to claim 1 comprising reducing torque applied to the third shaft when the instantaneous loading on the transmission system exceeds a load limit for the wave energy converter.

13. A method of operating a power take-off arrangement according to claim 1 comprising reducing torque applied to said the shaft to achieve a ‘survival’ state

14. A method of operating a power take-off arrangement according to claim 1 comprising modulating the torque to maintain a constant rotation speed at a main generator.

15. A method of operating a power take-off arrangement according claim 1 comprising applying torque to the third shaft and the electrical generator or motor generator generating electricity which may be exported to the grid or used to power on-board systems.
